(19) United States
(12) Patent Application Publication
(10) Pub. No.: US 2025/0267012 A1
(43) Pub. Date: Aug. 21, 2025

(54) PROCESSOR, SYSTEM AND METHOD FOR INFORMATION AUTHENTICATION

(71) Applicant: BOE TECHNOLOGY GROUP CO., LTD., Beijing (CN)

(72) Inventors: Hongjun DU, Beijing (CN); Xitong MA, Beijing (CN); Haitao ZHENG, Beijing (CN); Tao LI, Beijing (CN); Xingxing ZHAO, Beijing (CN)

(21) Appl. No.: 18/701,220

(22) PCT Filed: Dec. 26, 2022
(86) PCT No.: PCT/CN2022/142029

§ 371 Date: Apr. 13, 2024

(51) Int. Cl. H04L 9/32; H04L 9/08

(52) U.S. Cl. CPC H04L 9/3263; H04L 9/0825

(57) ABSTRACT

A processor, an information authentication system and an information authentication method are provided. The processor includes: a device driving module for driving a key device and reading a first digital certificate stored in the key device, with first encrypted data in the first digital certificate being encrypted with a second private key; a first authentication module for decrypting the first encrypted data with a second public key in a second digital certificate to obtain and authenticate a first decryption result; a second authentication module for authenticating the key device with the first digital certificate in response to that the first decryption result is authenticated successfully; a third authentication module for parsing and authenticating identity information of a protected object in the first digital certificate in response to that the key device is authenticated successfully, and calling the protected object in response to that the identity information is authenticated successfully.

### TECHNICAL FIELD

The present disclosure relates to the field of information security technology, in particular to a processor, an information authentication system and an information authentication method.

### BACKGROUND

Containerization refers to packaging software codes and all desired components (e.g., libraries, frameworks, and other dependent items) together, so that they are isolated in their own “containers”. In this way, the software or applications within the container may be moved and run consistently in any environment and any infrastructure, without being affected by an operating system of the environment or infrastructure.

Artificial intelligence (AI) and machine learning (ML) containerization have many advantages in terms of modularization, reaction rate, management convenience and the like. Since the container has excellent characteristics such as light weight, safety, second-level starting and the like, and is naturally light-weighted and portable so that the container is very suitable for the edge calculation scene, a cloud end and an edge end of the AI algorithm tend to be deployed in the containerization at present.

### SUMMARY

The present disclosure is directed to solve at least one of the technical problems in the related art, and provides a processor, an information authentication system, and an information authentication method.

In a first aspect, the technical solution adopted to solve the technical problem in the related art is a processor communicatively connected to a key device, the processor includes a device driving module, a first authentication module, a second authentication module and a third authentication module; the device driving module is configured to drive the key device and read a first digital certificate stored in the key device; first encrypted data in the first digital certificate is encrypted by using a second private key; the first authentication module is configured to decrypt the first encrypted data in the first digital certificate by using a second public key preset in a second digital certificate to obtain a first decryption result, and authenticate the first decryption result; the second public key in the second digital certificate is paired with the second private key; the second authentication module is configured to authenticate the key device by using the first digital certificate in response to that the first decryption result is authenticated successfully; and the third authentication module is configured to parse and authenticate identity information of a protected object in the first digital certificate in response to that the key device is authenticated successfully, and call the protected object in response to that the identity information is authenticated successfully.

In some implementations, the first digital certificate includes the first encrypted data, a hash algorithm, and a first public key; the first encrypted data is obtained by encrypting a first hash value based on the second private key, and the first hash value is obtained by processing the first public key generated by the key device by using the hash algorithm; the first public key and a first private key are paired with each other; and the second digital certificate includes the second public key corresponding to the second private key; the first authentication module is configured to decrypt the first encrypted data by using the second public key to obtain the first decryption result; process the first public key by using the hash algorithm in the first digital certificate to obtain a second hash value; and compare the second hash value with the first decryption result to judge whether the first decryption result is authenticated successfully

In some implementations, the first digital certificate includes the first encrypted data and a first public key; the first encrypted data is obtained by encrypting the first public key generated by the key device based on the second private key; and the second digital certificate includes the second public key corresponding to the second private key; the first authentication module is configured to decrypt the first encrypted data by using the second public key to obtain the first decryption result; and compare the first public key in the first digital certificate with the first decryption result to judge whether the first decryption result is authenticated successfully

In some implementations, the second authentication module is configured to generate random data and send the random data to the key device in response to that the first decryption result is authenticated successfully; read second encrypted data in the key device, and decrypt the second encrypted data by using the first public key in the first digital certificate to obtain a second decryption result; compare the second decryption result with the random data, to judge whether the second decryption result is valid; the second encrypted data is obtained by encrypting the random data by the key device by using the first private key generated in advance.

In some implementations, the first digital certificate includes the identity information of the protected object; and the third authentication module is configured to parse the identity information of the protected object in the first digital certificate, and acquire the identity information of the protected object, stored in advance, in response to that the key device is authenticated successfully; and compare the identity information obtained by parsing with the identity information stored in advance, to judge whether the identity information of the protected object is authenticated successfully.

In a second aspect, an embodiment of the present disclosure further provides an information authentication system, which includes a key device and the processor as described above; the key device is communicatively connected to the processor; the processor includes a device driving module, a first authentication module, a second authentication module and a third authentication module; the key device is configured to store a first digital certificate; first encrypted data in the first digital certificate is encrypted by using a second private key; the device driving module is configured to drive the key device and read the first digital certificate stored in the key device; the first authentication module is configured to decrypt the first encrypted data in the first digital certificate by using a second public key in a second digital certificate stored in advance to obtain a first decryption result, and authenticate the first decryption result; the second public key in the second digital certificate is paired with the second private key; the second authentication module is configured to authenticate the key device by using the first digital certificate in response to that the first decryption result is authenticated successfully; and the third authentication module is configured to parse and authenticate identity information of a protected object in the first digital certificate in response to that the key device is authenticated successfully, and call the protected object in response to that the identity information is authenticated successfully.

In some implementations, the second authentication module is configured to generate random data and send the random data to the key device in response to that the first decryption result is authenticated successfully; and read second encrypted data, and decrypt the second encrypted data by using the first public key in the first digital certificate to obtain a second decryption result; compare the second decryption result with the random data, to judge whether the second decryption result is valid; and the key device is further configured to encrypt the random data by using a first private key generated in advance to obtain the second encrypted data.

In some implementations, the key device includes a hardware security module (HSM).

In a third aspect, an embodiment of the present disclosure further provides an information authentication system, which includes a key device, an authentication device, and the processor as described above; the key device, the processor and the authentication device are communicatively connected to each other; the processor includes a device driving module, a first authentication module, a second authentication module and a third authentication module; the key device is configured to store a first digital certificate; first encrypted data in the first digital certificate is encrypted by using a second private key; the authentication device is configured to generate the first digital certificate and a second digital certificate; a second public key in the second digital certificate is paired with the second private key; the device driving module is configured to drive the key device and read the first digital certificate stored in the key device; the first authentication module is configured to decrypt the first encrypted data in the first digital certificate by using the second public key in the second digital certificate to obtain a first decryption result, and authenticate the first decryption result; the second authentication module is configured to authenticate the key device by using the first digital certificate in response to that the first decryption result is authenticated successfully; and the third authentication module is configured to parse and authenticate identity information of a protected object in the first digital certificate in response to that the key device is authenticated successfully, and call the protected object in response to that the identity information is authenticated successfully.

In some implementations, the authentication device includes a generation module and an encryption module; the key device is configured to generate a first private key and a first public key; and acquire and store the first digital certificate; the generation module is configured to generate the second private key and the second digital certificate corresponding to the second private key; and the encryption module is configured to read the first public key, generate the first digital certificate according to the second private key and the first public key, and write the first digital certificate into the key device.

In some implementations, the encryption module is configured to process the first public key by using a hash algorithm to obtain a first hash value; encrypt the first hash value by using the second private key to obtain the first encrypted data; and the first digital certificate includes the first encrypted data, the hash algorithm, and the first public key; the second digital certificate includes the second public key corresponding to the second private key; the first authentication module is configured to decrypt the first encrypted data by using the second public key to obtain the first decryption result; process the first public key by using the hash algorithm in the first digital certificate to obtain a second hash value; and compare the second hash value with the first decryption result to judge whether the first decryption result is authenticated successfully

In some implementations, the encryption module is configured to encrypt the first public key by using the second private key to obtain the first encrypted data; and the first digital certificate includes the first encrypted data and the first public key; the second digital certificate includes the second public key corresponding to the second private key; the first authentication module is configured to decrypt the first encrypted data by using the second public key to obtain the first decryption result; and compare the first public key in the first digital certificate with the first decryption result to judge whether the first decryption result is authenticated successfully

In some implementations, the second authentication module is configured to generate random data and send the random data to the key device in response to that the first decryption result is authenticated successfully; and read second encrypted data, and decrypt the second encrypted data by using the first public key in the first digital certificate to obtain a second decryption result; compare the second decryption result with the random data, to judge whether the second decryption result is valid; and the key device is further configured to encrypt the random data by using the first private key generated in advance to obtain the second encrypted data.

In some implementations, the first digital certificate includes the identity information of the protected object; the third authentication module is configured to parse the identity information of the protected object in the first digital certificate, and acquire the identity information of the protected object stored in advance, in response to that the key device is authenticated successfully; and compare the identity information obtained by parsing with the identity information stored in advance, to judge whether the identity information of the protected object is authenticated successfully

In a fourth aspect, an embodiment of the present disclosure further provides an information authentication method, including: reading a first digital certificate stored in a key device, with first encrypted data in the first digital certificate being encrypted by using a second private key; decrypting the first encrypted data in the first digital certificate by using a second public key in a second digital certificate to obtain a first decryption result, and authenticating the first decryption result, with the second public key in the second digital certificate being paired with the second private key; authenticating the key device by using the first digital certificate in response to that the first decryption result is authenticated successfully; and parsing and authenticating identity information of a protected object in the first digital certificate in response to that the key device is authenticated successfully, and calling the protected object in response to that the identity information is authenticated successfully.

In a fifth aspect, an embodiment of the present disclosure further provides computer device, including: a processor, a memory and a bus, the memory stores machine-readable instructions to be executed by the processor; the processor and the memory are communicated with each other through the bus during the computer device operating; the machine-readable instructions cause the processor to perform the information authentication method described above.

In a sixth aspect, an embodiment of the present disclosure further provides a non-transitory computer readable storage medium storing thereon a computer program, and the computer program is to be executed by a processor to cause the processor to perform the information authentication method described above.

### BRIEF DESCRIPTION OF DRAWINGS

FIG. 1 is a schematic diagram of a processor according to an embodiment of the present disclosure;

FIG. 2 is a schematic flowchart of a processor service according to an embodiment of the present disclosure;

FIG. 3 is a schematic diagram of an information authentication system according to an embodiment of the present disclosure;

FIG. 4 is a schematic flowchart illustrating information interaction between a key device and a processor according to an embodiment of the present disclosure;

FIG. 5 is a schematic diagram of another information authentication system according to an embodiment of the present disclosure;

FIG. 6 is a schematic diagram illustrating information interaction between a key device and an authentication device according to an embodiment of the present disclosure;

FIG. 7 is a schematic flowchart of an information authentication method according to an embodiment of the present disclosure; and

FIG. 8 is a schematic diagram of a structure of a computer device according to an embodiment of the present disclosure.

### DETAIL DESCRIPTION OF EMBODIMENTS

To make the objects, technical solutions and advantages of the embodiments of the present disclosure more apparent, the technical solutions of the embodiments of the present disclosure will be clearly and completely described below with reference to the drawings of the embodiments of the present disclosure. It is to be understood that the described embodiments are only a few, not all of, embodiments of the present disclosure. Components of the embodiments of the present disclosure, as generally described and illustrated in the drawings herein, could be arranged and designed in a wide variety of different configurations. Thus, the following detailed description of the embodiments of the present disclosure in the drawings is not intended to limit the claimed scope of the present disclosure, but is merely representative of selected embodiments of the present disclosure. All other embodiments, which can be derived by a person skilled in the art from the described embodiments of the present disclosure without any inventive step, are within the scope of the present disclosure.

Unless defined otherwise, technical or scientific terms used herein shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. Further, the term “a”, “an”, “the”, or the like used herein does not denote a limitation of quantity, but rather denotes the presence of at least one element. The term of “comprising”, “including”, or the like, means that the element or item preceding the term contains the element or item listed after the term and its equivalent, but does not exclude other elements or items. The term “connected”, “coupled”, or the like is not limited to physical or mechanical connections, but may include electrical connections, whether direct or indirect connections. The terms “upper”, “lower”, “left”, “right”, and the like are used only for indicating relative positional relationships, and when the absolute position of an object being described is changed, the relative positional relationships may be changed accordingly.

Reference to “a plurality or a number” in the present disclosure means two or more. Reference to “and/or” describes association relationships among associated objects, indicating that there may be three relationships. For example, A and/or B may indicate: A alone, A and B, or B alone. The character “/” generally indicates that the associated objects before and after the “/” are in an “or” relationship.

In the related art, a container is started based on a mirror image. If the mirror image is copied to another machine for starting and running, resources stored in the container may be leaked, so that the information security is threatened. However, the container is a virtual environment that runs on a host in an isolated manner, and cannot be protected by binding hardware information (such as an operating system or a processor) of the host.

In view of above, in order to solve one or more technical problems mentioned above, an embodiment of the present disclosure provides a processor, which is communicatively connected to a key device, so that identity authentication of an operating user of the processor (i.e., a user operating the processor) and identity authentication of a protected object stored in the processor are implemented, and the protected object stored in the processor can be protected without binding the hardware information of the host; a content of the protected object is stored in a container technology, and the stored content and its dependency relationship are packaged together. Specifically, the processor is communicatively connected to the key device; the processor includes a device driving module, a first authentication module, a second authentication module, and a third authentication module. The device driving module is configured to drive the key device and read a first digital certificate stored in the key device; first encrypted data in the first digital certificate is encrypted by using a second private key; the first authentication module is configured to decrypt the first encrypted data in the first digital certificate by using a second public key preset in a second digital certificate, to obtain a first decryption result, and authenticate the first decryption result; the second public key in the second digital certificate is paired with the second private key; the second authentication module is configured to authenticate the key device by using the first digital certificate in response to that the first decryption result is authenticated successfully; the third authentication module is configured to parse and authenticate identity information of the protected object in the first digital certificate in response to that the key device is authenticated successfully, and call the protected object in response to that the identity information is authenticated successfully; the first authentication module, the second authentication module, and the third authentication module may be the same authentication module.

In the embodiment of the present disclosure, the device driving module drives the key device, so that the first digital certificate stored in the key device can be effectively read. It should be noted that the first encrypted data in the first digital certificate is encrypted by using the second private key; the second private key is paired with the second public key; the second public key is stored in the second digital certificate; the second digital certificate is pre-stored within the processor. Firstly, the second public key preset in the second digital certificate is utilized to decrypt the first encrypted data in the first digital certificate, to obtain and authenticate the first decryption result, so that a secure transmission of the first encrypted data is realized. Further, in response to that the first decryption result is authenticated successfully, the key device is authenticated by using the first digital certificate. It should be noted that although the first digital certificate sent by the key device is authenticated successfully, it does not represent that the key device itself is legal, and the key device may steal the first digital certificate authenticated successfully. Therefore, the first digital certificate authenticated successfully is used for further authenticating the key device reversely, so that the identity authentication of the operating user of the processor is realized. That is, the key device currently mounted can be ensured to be legal in response to that the key device is authenticated successfully. The identity information of the protected object in the first digital certificate is parsed and authenticated in response to that the key device is authenticated successfully. It should be noted that although the key device is authenticated successfully, the identity information of the protected object in the first digital certificate may not be consistent with the identity information of the protected object currently stored in the processor, and therefore, after the identity information of the protected object in the first identity certificate is parsed, the identity information s further authenticated; and the object (i.e., the protected object in the first digital certificate) that the user instructs to manipulate is the protected object stored in the processor, so that the protected object is authorized to be available, and a secure call of the protected object is realized.

To facilitate an understanding of the embodiments of the present disclosure, before specifically describing the processor, specific terms used in the embodiments of the present disclosure are to be interpreted in detail as follows.

1) A CA (certification authority) is an international generic name of an authority that issues, manages, and cancels a digital certificate for an applicant. The role of the CA is to check a legitimacy of an identity of a certificate holder and to sign and issue a certificate (mathematically sign on the certificate) in order to avoid the certificate to be forged or tampered with. A digital certificate authority (CA) is a key part for security of electronic transactions (online transactions) over the network. The digital certificate authority is mainly responsible for generating, distributing and managing digital certificates for identity authentication of all entities participating in the online transactions. Each digital certificate is associated with a higher-level digital signature certificate, and is finally to be traced back to a root certification authority (root CA) through a security chain; the root certification authority (root CA) is known and is widely recognized to be secure, authoritative, and trustworthy.

2) A hardware security module (HSM) is a computer hardware device configured to protect and manage a key to be used by a strong authentication system, and to provide associated cryptographic operations. The hardware security module is typically connected directly to a computer or a network server in the form of an expansion card or an external device.

3) A digital signature (also called a public key digital signature) is a numeric string which can be generated only by an information sender and cannot be forged by others, and the numeric string is a valid proof for the authenticity of the information sent by the information sender. The digital signature is similar to a normal physical signature written on a paper, and is implemented by using techniques in the field of public key cryptography, and is a method for authenticating digital information. A set of digital signatures typically defines two complementary operations, one for signing and the other for authenticating. The signature involved in the embodiments of the present disclosure includes a private key for signing and issuing and a public key for authenticating.

4) A digital certificate (also called a public key certificate) is a statement for the digital signature and binds a value of a public key to an identity of a person, a device, or a service holding the private key. Most commonly used certificates are based on the X.509v3 certificate standard. First and second digital certificates in the present disclosure are all based on the X.509v3 certificate standard.

5) Hash is used to convert an input (also called a pre-image) with an arbitrary length into an output with a fixed length through a hash algorithm, and the output is a hash value. This conversion is a kind of compression mapping. That is, a space of the hash value is usually much smaller than that of the input, and different inputs may be hashed (converted) into the same output, therefore it is not possible to determine a unique input value from the hash value. In short, the hash is a function for compressing a message with an arbitrary length to a message digest with a fixed length.

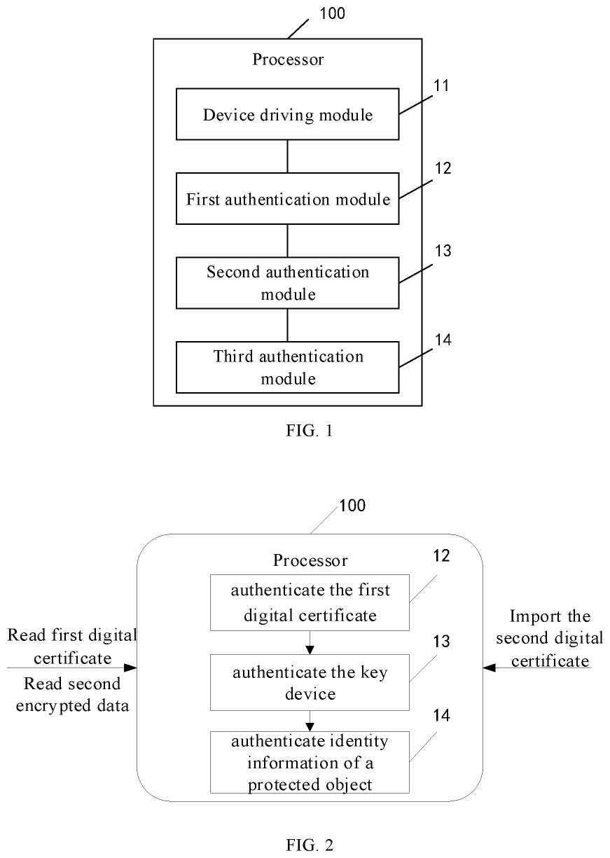

Specific functional modules of a processor provided in an embodiment of the present disclosure are described in detail below. FIG. 1 is a schematic diagram of a processor according to an embodiment of the present disclosure. As shown in FIG. 1, a processor 100 includes a device driving module 11, a first authentication module 12, a second authentication module 13, and a third authentication module 14. These three authentication modules respectively realize the authentication of three different kinds of information and a multiple information authentication mechanism, which improves the information security of the protected object.

The device driving module 11 is configured to drive a key device 200 and read a first digital certificate stored in the key device 200. Here, the first digital certificate includes at least first encrypted data, the first encrypted data is encrypted by using a second private key; the second private key is paired with a second public key; and the second private key and the second public key may be generated by a CA server. For example, the second public key may be a public key provided in a second digital certificate, and the second digital certificate is a public key root certificate issued by the CA server. Illustratively, the device driving module 11 may be formed by codes, stored in the processor 100, for driving the key device 200. The key device 200 may be a hardware security module (HSM) held by a user.

The first authentication module 12 is configured to decrypt the first encrypted data in the first digital certificate by using the second public key preset in the second digital certificate, to obtain and authenticate a first decryption result. Here, according to an asymmetric encryption and decryption principle, the first encrypted data in the first digital certificate is encrypted by using the second private key, and accordingly, the first authentication module 12 is to decrypt by using the second public key paired with the second private key. Specifically, the processor 100 imports the second digital certificate from the CA server in advance, the second digital certificate includes at least the second public key, and the first encrypted data is decrypted by using the second public key in the second digital certificate, so as to obtain the first decryption result. Then, the first decryption result is authenticated by using a first preset algorithm. If the first decryption result is authenticated successfully, it indicates that the first digital certificate stored in the key device 200 communicatively connected to the processor 100 is accurate.

The second authentication module 13 is configured to authenticate the key device 200 by using the first digital certificate in response to that the first decryption result is authenticated successfully. Here, the key device 200 stores therein the first private key. In response to that the first decryption result is authenticated successfully, the second authentication module 13 is to be started to generate data to be encrypted; and the device driving module 11 calls an interface of the key device 200 to write the data to be encrypted, and the key device 200 may sign the data to be encrypted by using the first private key, to obtain second encrypted data; the device driving module 11 reads the second encrypted data, and the second authentication module 13 decrypts the second encrypted data, for example, by using the first public key in the first digital certificate that is authenticated successfully, so as to obtain a second decryption result; and then, the second decryption result is authenticated by using a second preset algorithm, and if the second decryption result is authenticated successfully, it indicates that the key device 200 is authenticated successfully. Here, the data to be encrypted may be a random number generated randomly, or may be fixed data provided according to a preset rule, or the like.

The third authentication module 14 is configured to parse and authenticate identity information of a protected object in the first digital certificate in response to that the key device 200 is authenticated successfully, and to call the protected object in response to that the identity information is authenticated successfully. Here, the first digital certificate stores therein the identity information of the protected object, such as an identity document (id), or information such as a name capable of characterizing the identity of the protected object. In response to that the key device 200 is authenticated successfully, the third authentication module 14 is started to parse the identity information of the protected object in the first digital certificate, and authenticate the identity information by using a third preset algorithm. If the identity information is authenticated successfully, it indicates that the identity of the protected object in the key device 200 held by the user is authenticated successfully and the identity of the protected object in the first digital certificate is the same as the identity of the protected object stored in the processor 100, therefore the protected object is authorized to be available, and the secure call of the protected object is realized.

For example, if the protected object is a preset AI algorithm, the secure call may be understood that the current operating environment of the processor 100 is safe enough to operate the AI algorithm; alternatively, the processor 100 in which the AI algorithm is currently located is secure, and therefore the AI algorithm may be deployed to any processor to run; alternatively, the AI algorithm may be allowed to be called from the processor 100 to run in another run environment.

FIG. 2 is a schematic flowchart of a processor service according to an embodiment of the present disclosure. As shown in FIG. 2, three different information authentication mechanisms corresponding to three authentication modules are included, the first authentication module 12 is configured to authenticate the first digital certificate; the second authentication module 13 is configured to authenticate the key device 200; the third authentication module 14 is configured to authenticate the identity information of the protected object. The embodiment of the present disclosure improves the information security of the protected object through a multiple information authentication mechanism.

In some implementations, the first digital certificate includes the first encrypted data, a hash algorithm Hash, and the first public key; the first encrypted data is obtained by encrypting a first hash value based on the second private key, the first hash value is obtained by processing the first public key generated by the key device 200 by using the hash algorithm Hash. Here, the first public key and the first private key, which are generated and stored by the key device 200, are paired with each other.

The process of generating the first digital certificate is a preprocessing process. Specifically, the first digital certificate may be generated on the CA server. For example, the CA server is configured to receive the first public key sent by the key device 200, and perform a hash operation on the first public key by using the hash algorithm to obtain a first hash value; the CA server stores the second private key and the second public key thereon, and is configured to encrypt the first hash value by using the second private key to obtain the first encrypted data, and package the first encrypted data, the hash algorithm Hash and the first public key to generate the first digital certificate, and write the first digital certificate into the key device 200.

It should be noted that in a case where the data characterizing the first public key is relatively much in content and is relatively large in volume, the hash algorithm may be first adopted to reduce the volume of the data to be encrypted, so as to obtain the first hash value; and then, the first hash value is encrypted, so that the efficiency of encrypting is improved, thereby the resource to be stored is reduced, and the expectation on performances of an equipment for encrypting is reduced.

The first preset algorithm may be an information comparison algorithm, which, for example, compares the second hash value with the first decryption result. The second digital certificate includes the second public key corresponding to the second private key. The first authentication module 12 is specifically configured to decrypt the first encrypted data by using the second public key to obtain the first decryption result; process the first public key by using the hash algorithm in the first digital certificate to obtain the second hash value; and compare the second hash value with the first decryption result to judge whether the first decryption result is authenticated successfully

Here, according to the asymmetric encryption and decryption principle, the first encrypted data in the first digital certificate is encrypted by using the second private key, and accordingly, the first authentication module 12 is to decrypt by using the second public key paired with the second private key. Specifically, according to a process reverse to the encrypting described above, if the first encrypted data is not tampered with, the first decryption result should be the first hash value obtained by performing the hash operation on the first public key by using the hash algorithm. Therefore, the first decryption result is to be authenticated by using the hash value obtained above. Specifically, the hash operation is performed on the first public key by using the hash algorithm in the first digital certificate to obtain the second hash value; the second hash value is compared with the first decryption result, and if the first encrypted data is not tampered with, the first decryption result is the same as the first hash value. It should be noted that the process for calculating the second hash value is the same as that for calculating the first hash value, and thus the second hash value is the same as the first hash value, the second hash value is the same as the first decryption result, and the first decryption result is authenticated to be valid; if the first encrypted data is tampered with, the first decryption result is different from the first hash value, and in response to that the second hash value is the same as the first hash value, it is determined that the first decryption result is different from the second hash value, and therefore the first decryption result is authenticated unsuccessfully.

In some implementations, the first digital certificate includes the first encrypted data and the first public key; the first encrypted data is obtained by encrypting the first public key, generated by the key device 200, based on the second private key. Here, if the data characterizing the first public key has relatively little content, the original first public key may be directly encrypted without the hash operation, and the hash operation can be canceled to improve the efficiency of encrypting. As can be seen from the foregoing description of the embodiment, the first encrypted data is generated by using the CA server, and the CA server is configured to encrypt the first public key by using the second private key to obtain the first encrypted data, and package the first encrypted data and the first public key to generate the first digital certificate, and write the first digital certificate into the key device 200.

The first preset algorithm may be the information comparison algorithm, which, for example, compares the first public key in the first digital certificate with the first decryption result. The second digital certificate includes the second public key corresponding to the second private key; the first authentication module 12 is specifically configured to decrypt the first encrypted data by using the second public key to obtain the first decryption result; and compare the first public key in the first digital certificate with the first decryption result to judge whether the first decryption result is authenticated successfully

Here, according to the asymmetric encryption and decryption principle, the first encrypted data in the first digital certificate is encrypted by using the second private key, and accordingly, the first authentication module 12 is to decrypt by using the second public key paired with the second private key. Specifically, according to a process reverse to the encrypting described above, if the first encrypted data is not tampered with, the first decryption result should be the data characterizing the first public key, that is, the first public key. Therefore, the first public key in the first digital certificate may be directly compared with the first decryption result, and if the first public key and the first decryption result are the same, it indicates that the first encrypted data is not tampered with, and thus it is determined that the first decryption result is authenticated successfully If the first public key and the first decryption result are different from each other, it is determined that the first decryption result is authenticated unsuccessfully. The reason for the first decryption result being authenticated unsuccessfully may include that the first decryption result is tampered with during being transmitted, or the first public key in the first digital certificate is tampered with, and the like, which causes that the original first digital certificate is changed, and thus it is determined that the first decryption result is authenticated unsuccessfully.

In some implementations, the second preset algorithm may be an information comparison algorithm, which, for example, compares random data with the second decryption result. The second authentication module 13 is specifically configured to generate random data and send the random data to the key device 200 in response to that the first decryption result is authenticated successfully; read the second encrypted data in the key device 200, and decrypt the second encrypted data by using the first public key in the first digital certificate to obtain the second decryption result; and compare the second decryption result with the random data, and judge whether the second decryption result is authenticated successfully Here, the second encrypted data is obtained by encrypting a random number by the key device 200 using the first private key generated in advance. Here, the random data may be a random number randomly generated by the second authentication module 13, and the random number has a relatively small data volume.

In this way, the information interaction between the second authentication module 13 and the key device 200 is realized. Firstly, in response to that the first decryption result is authenticated successfully, the second authentication module 13 is to be started for authenticating the key device 200. The second authentication module 13 is specifically configured to generate a random number, write the random number into the key device 200, and the key device 200 is configured to read the random number and encrypt the random number with the first private key generated in advance to obtain the second encrypted data. Moreover, the second authentication module 13 is further configured to read the second encrypted data, and decrypt the second encrypted data by using the first public key in the first digital certificate, which is authenticated successfully, according to the asymmetric encryption and decryption principle, so as to obtain the second decryption result. According to ta process reverse to the encrypting described above, if the second encrypted data is not tampered with, the second decryption result is the random number unencrypted. It should be noted that the random number is randomly generated by the second authentication module, and therefore the second authentication module can record the random number randomly generated. After the second decryption result is obtained, the random number stored is compared with the second decryption result, and if the random number and the second decryption result are the same, it indicates that the second encrypted data is not tampered with, and thus it is determined that the second decryption result is valid, that is, the key device 200 is authenticated successfully. If the random number and the second decryption result are different from each other, it is determined that the second decryption result is authenticated unsuccessfully, that is, the key device 200 is authenticated unsuccessfully. The key device 200 being authenticated successfully indicates that the user holding the key device 200 is authenticated successfully.

In some implementations, the third preset algorithm may be an information comparison algorithm, which, for example, compares the identity information of the protected object stored in advance with the identity information of the protected object obtained by parsing.

The first digital certificate also includes the identity information of the protected object; the third authentication module 14 is specifically configured to, in response to that the key device 200 is authenticated successfully, parse the identity information of the protected object in the first digital certificate, and acquire the identity information of the protected object stored in advance; and compare the identity information obtained by parsing with the identity information stored in advance, and judge whether the identity information of the protected object is authenticated successfully

The identity information of the protected object contained in the first digital certificate may be generated by packaging the identity information of the protected object together with the first encrypted data and the first public key during the CA server generating the first digital certificate. For example, a X.509 certificate field includes a CommonName (CN) field for holding the identity document (id) of the protected object.

If the identity information of the protected object in the first digital certificate is not tampered with, the identity information obtained by parsing is the same as the identity information stored in advance, and thus it is determined that the identity information of the protected object is authenticated successfully If the identity information obtained by parsing is different from the identity information stored in advance, it is determined that the identity information of the protected object is authenticated unsuccessfully.

It should be noted that different protected objects may be stored in the processor 100 at different times, or multiple users may be authorized simultaneously, but key devices 200 held by different users are different, and protected objects in first digital certificates stored in the key devices 200 have different identity information. The key device 200 held by any user may be authenticated successfully by the processor 100. For example, the user is granted the right to call the protected object A previously stored in the processor 100, but the user does not have the right to call the current protected object B, so that in the embodiment of the present disclosure, the identity information of the protected object is further authenticated in a case where the first decryption result is authenticated successfully by the first authentication module 12 and the key device 200 is authenticated successfully by the second authentication module 13. With such multiple information authentication mechanism, the information security of the protected object is improved.

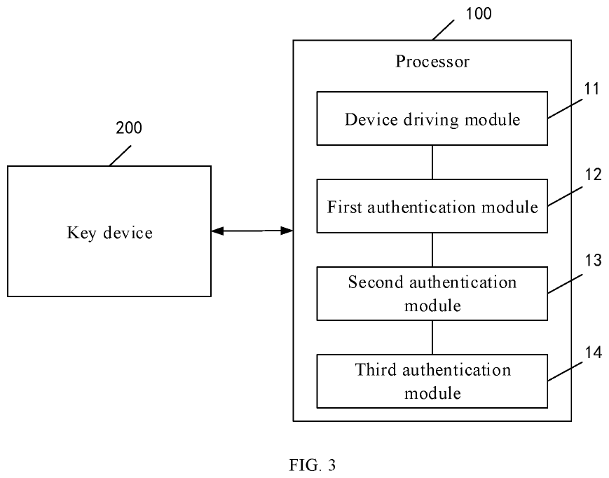

An embodiment of the present disclosure further provides an information authentication system. FIG. 3 is a schematic diagram of an information authentication system according to an embodiment of the present disclosure. As shown in FIG. 3, the information authentication system includes the key device 200 and the processor 100. The key device 200 is communicatively connected to the processor 100. The processor 100 includes the device driving module 11, the first authentication module 12, the second authentication module 13, and the third authentication module 14, the first authentication module 12, the second authentication module 13, and the third authentication module 14 may be the same authentication module.

The key device 200 is configured to store the first digital certificate; the first encrypted data in the first digital certificate is encrypted by using the second private key. Here, the key device 200 generates the first private key and the first public key which are paired with each other. The first digital certificate includes the first public key. The second private key is paired with the second public key, and the second private key and the second public key may be generated by the CA server. The first digital certificate is generated by the CA server. For example, the CA server encrypts the first public key by using the second private key to obtain the first encrypted data, and packages the first encrypted data and the first public key to generate the first digital certificate, and writes the first digital certificate into the key device 200.

The device driving module 11 is configured to drive the key device 200 and read the first digital certificate stored in the key device 200. Illustratively, the device driving module 11 may be formed by codes, stored in the processor 100, for driving the key device 200, and the codes may be driven to call some functional interfaces of the key device 200.

The first authentication module 12 is configured to decrypt the first encrypted data in the first digital certificate by using the second public key in the second digital certificate stored in advance to obtain and authenticate the first decryption result; the second public key in the second digital certificate is paired with the second private key. Here, the second public key may be a public key provided in the second digital certificate, the second digital certificate is a public key root certificate issued by the CA server. It should be noted that, for the process of authenticating of the first authentication module 12, reference may be made to the foregoing description of the specific implementation of the first authentication module 12, and repeated description is not to be provided.

The second authentication module 13 is configured to authenticate the key device 200 by using the first digital certificate in response to that the first decryption result is authenticated successfully. It should be noted that, for the process of authenticating of the second authentication module 13, reference may be made to the foregoing description of the specific implementation of the second authentication module 13, and repeated description is not to be provided.

The third authentication module 14 is configured to, in response to that the key device 200 is authenticated successfully, parse and authenticate the identity information of the protected object in the first digital certificate, and in response to that the identity information is authenticated successfully, call the protected object. It should be noted that, for the process of authenticating of the third authentication module 14, reference may be made to the foregoing description of the specific implementation of the third authentication module 14, and repeated description is not to be provided.

In some implementations, the first digital certificate includes the first encrypted data, the hash algorithm, and the first public key; the first encrypted data is obtained by encrypting the first hash value based on the second private key, the first hash value is obtained by processing the first public key generated by the key device 200 by using the hash algorithm. The first public key and the first private key are paired with each other; the second digital certificate includes the second public key corresponding to the second private key; the first authentication module 12 is specifically configured to decrypt the first encrypted data by using the second public key to obtain the first decryption result; process the first public key by using the hash algorithm in the first digital certificate to obtain the second hash value; and compare the second hash value with the first decryption result to judge whether the first decryption result is authenticated successfully

It should be noted that, for the process of authenticating of the first authentication module 12, reference may be made to the foregoing description of the specific implementation of the first authentication module 12, and repeated description is not to be provided.

In some implementations, the first digital certificate includes the first encrypted data and the first public key; the first encrypted data is obtained by encrypting the first public key generated by the key device 200 based on the second private key; the second digital certificate includes the second public key corresponding to the second private key; the first authentication module 12 is specifically configured to decrypt the first encrypted data by using the second public key to obtain the first decryption result; and compare the first public key in the first digital certificate with the first decryption result to judge whether the first decryption result is authenticated successfully

It should be noted that, for the process of authenticating of the first authentication module 12, reference may be made to the foregoing description of the specific implementation of the first authentication module 12, and repeated descriptions are not repeated.

In some implementations, the second authentication module 13 authenticates the key device 200 through information interaction between the second authentication module 13 and the key device 200. The second authentication module 13 is specifically configured to generate and send random data to the key device 200 in response to that the first decryption result is authenticated successfully; read the second encrypted data, and decrypt the second encrypted data by using the first public key in the first digital certificate to obtain the second decryption result; and compare the second decryption result with the random data, to judge whether the second decryption result is authenticated successfully It should be noted that, for the process of authenticating of the second authentication module 13, reference may be made to the foregoing description of the specific implementation of the second authentication module 13, and repeated description is not to be provided.

Here, the random data may be a random number randomly generated by the second authentication module 13, and the random number has a relatively small data volume.

The key device 200 is further configured to encrypt the random data with the first private key generated in advance to obtain the second encrypted data.

In some implementations, the first digital certificate further includes the identity information of the protected object; the third authentication module 14 is specifically configured to, in response to that the key device 200 is authenticated successfully, parse the identity information of the protected object in the first digital certificate, and acquire the identity information of the protected object stored in advance; and compare the identity information obtained by parsing with the identity information stored in advance, to judge whether the identity information of the protected object is authenticated successfully

It should be noted that, for the process of authenticating of the third authentication module 14, reference may be made to the foregoing description of the specific implementation of the third authentication module 14, and repeated description is not to be provided.

In some implementations, the key device 200 includes a hardware security module (HSM).

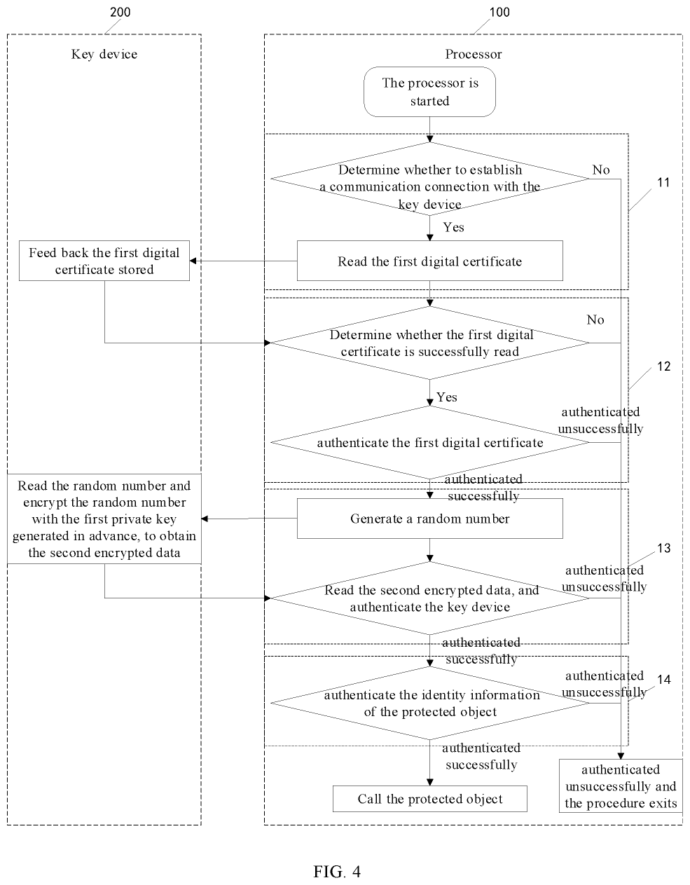

FIG. 4 is a schematic flowchart illustrating information interaction between a key device and a processor according to an embodiment of the present disclosure. As shown in FIG. 4, the key device 200 stores the first private key and the first digital certificate. The key device 200 is communicatively connected to the processor 100. For example, the key device 200 may be connected and mounted to the processor 100 via an interface. The processor 100 stores the second digital certificate in advance.

The processor 100 is started, that is, the device driving module 11 is started, to determine whether to establish a communication connection with the key device 200. In response to that the communication connection between the processor 100 and the key device 200 is established, the device driving module 11 is configured to read the first digital certificate stored in the key device 200; and the key device 200 is configured to feed back the first digital certificate stored; the first authentication module 12 is configured to determine whether the first digital certificate is successfully read, and authenticate the first digital certificate after the first digital certificate is successfully read; if the first digital certificate is unsuccessfully read, the first digital certificate is authenticated unsuccessfully, and the procedure exits; and if the first digital certificate is unsuccessfully authenticated, the procedure exits; if the first digital certificate is authenticated successfully, the second authentication module 13 is started, and the second authentication module 13 is configured to generate a random number and send the random number to the key device 200; and the key device 200 is configured to read the random number and encrypt the random number with the first private key generated in advance, to obtain the second encrypted data; the second authentication module 13 is configured to read the second encrypted data, and authenticate the key device 200; and if the key device 200 is authenticated unsuccessfully, the procedure exits; in response to that the key device 200 is authenticated successfully, the third authentication module 14 is started; the third authentication module 14 is configured to authenticate the identity information of the protected object; and in response to that the identity information is authenticated successfully, the protected object is called. For example, if the protected object is an AI algorithm, the AI algorithm may be normally run to provide a service, in response to that the identity information of the protected object is authenticated successfully; otherwise, in response to that the identity information is authenticated unsuccessfully, the procedure exits.

An embodiment of the present disclosure further provides an information authentication system. FIG. 5 is a schematic diagram of another information authentication system according to an embodiment of the present disclosure. As shown in FIG. 5, the information authentication system includes the key device 200, the authentication device 300, and the processor 100; the key device 200, the processor 100 and the authentication device 300 are communicatively connected with each other; the processor 100 includes the device driving module 11, the first authentication module 12, the second authentication module 13, and the third authentication module 14, the first authentication module 12, the second authentication module 13, and the third authentication module 14 may be the same authentication module.

The key device 200 is configured to store the first digital certificate; the first encrypted data in the first digital certificate is encrypted by using the second private key. Here, the key device 200 generates the first private key and the first public key which are paired with each other. The first digital certificate includes the first public key.

The authentication device 300 is configured to generate the first digital certificate and the second digital certificate. The second public key in the second digital certificate is paired with the second private key. Here, the authentication device 300 may be the CA server.

The device driving module 11 is configured to drive the key device 200 and read the first digital certificate stored in the key device 200. Illustratively, the device driving module 11 may be formed by codes, stored in the processor 100, for driving the key device 200, and the codes may be driven to call some functional interfaces of the key device 200.

The first authentication module 12 is configured to decrypt the first encrypted data in the first digital certificate by using the second public key in the second digital certificate to obtain and authenticate the first decryption result. It should be noted that, for the process of authenticating of the first authentication module 12, reference may be made to the foregoing description of the specific implementation of the first authentication module 12, and repeated description is not to be provided.

The second authentication module 13 is configured to authenticate the key device 200 by using the first digital certificate in response to that the first decryption result is authenticated successfully. It should be noted that, for the process of authenticating of the second authentication module 13, reference may be made to the foregoing description of the specific implementation of the second authentication module 13, and repeated description is not to be provided.

The third authentication module 14 is configured to, in response to that the key device 200 is authenticated successfully, parse and authenticate the identity information of the protected object in the first digital certificate, and in response to that the identity information is authenticated successfully, call the protected object. It should be noted that, for the process of authenticating of the third authentication module 14, reference may be made to the foregoing description of the specific implementation of the third authentication module 14, and repeated description is not to be provided.

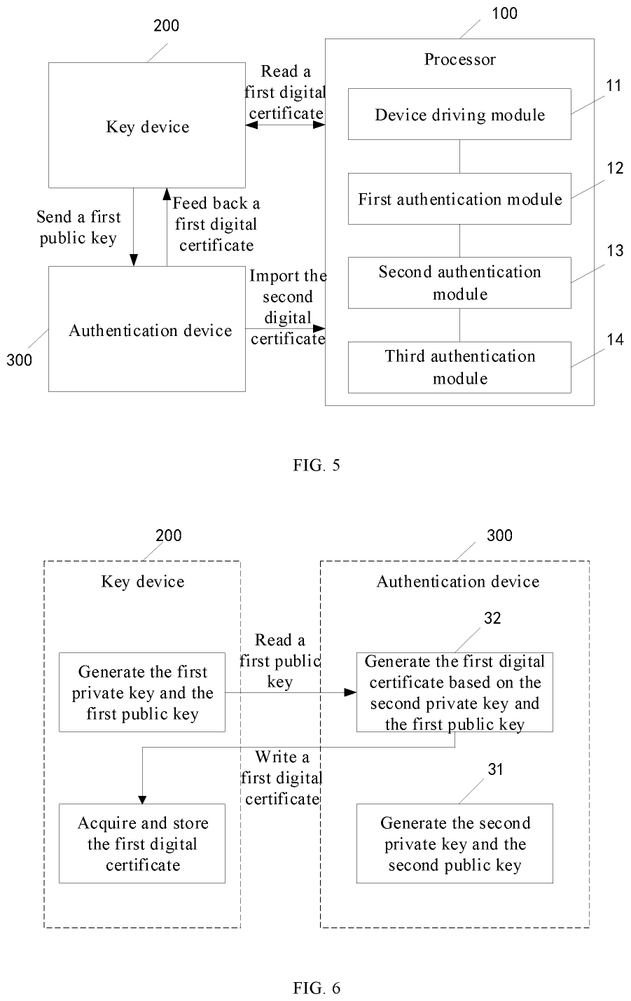

FIG. 6 is a schematic diagram illustrating information interaction between a key device and an authentication device according to an embodiment of the present disclosure. In some implementations, as shown in FIG. 6, the key device 200 is configured to generate the first private key and the first public key; and acquire and store the first digital certificate. The authentication device 300 includes a generation module 31 and an encryption module 32. The generation module 31 is configured to generate the second private key and the second digital certificate corresponding to the second private key. The second digital certificate includes the second public key. The generation module 31 is specifically configured to generate the second private key and the second public key, package the second public key, generate and store the second digital certificate. Subsequently, the processor 100 may import the second digital certificate from the authentication device 300 in advance. The encryption module 32 is configured to read the first public key, generate the first digital certificate based on the second private key and the first public key, and write the first digital certificate to the key device 200.

In some implementations, the generation module 31 may be further configured to package the second public key and the hash algorithm Hash, to generate and store the second digital certificate.

In some implementations, the encryption module 32 is specifically configured to process the first public key by using the hash algorithm to obtain the first hash value; and encrypt the first hash value by using the second private key to obtain the first encrypted data. Here, the hash algorithm may be the Hash algorithm. The encryption module 32 is further configured to package the first encrypted data, the first public key, and the hash algorithm, to generate and store the first digital certificate. The first digital certificate includes the first encrypted data, the hash algorithm, and the first public key. It should be noted that the process of generating the first digital certificate by the encryption module 32 is a preprocessing process, and the first digital certificate generated is written into the key device 200.

The second digital certificate includes the second public key corresponding to the second private key; the first authentication module 12 is specifically configured to decrypt the first encrypted data by using the second public key to obtain the first decryption result; process the first public key by using the hash algorithm in the first digital certificate to obtain the second hash value; and compare the second hash value with the first decryption result to judge whether the first decryption result is authenticated successfully. It should be noted that, for the process of authenticating of the first authentication module 12, reference may be made to the foregoing description of the specific implementation of the first authentication module 12, and repeated description is not to be provided.

In some implementations, the encryption module 32 is configured to encrypt the first public key by using the second private key, to obtain the first encrypted data. The encryption module 32 is further configured to package the first encrypted data and the first public key, to generate and store the first digital certificate. The first digital certificate includes the first encrypted data and the first public key. It should be noted that the process of generating the first digital certificate by the encryption module 32 is a preprocessing process, and the first digital certificate generated is written into the key device 200.

The second digital certificate includes the second public key corresponding to the second private key; the first authentication module 12 is specifically configured to decrypt the first encrypted data by using the second public key to obtain the first decryption result; and compare the first public key in the first digital certificate with the first decryption result to judge whether the first decryption result is authenticated successfully. It should be noted that, for the process of authenticating of the first authentication module 12, reference may be made to the foregoing description of the specific implementation of the first authentication module 12, and repeated description is not to be provided.

In some implementations, the second authentication module 13 is specifically configured to generate and send the random data to the key device 200 in response to that the first decryption result is authenticated successfully; read the second encrypted data, and decrypt the second encrypted data by using the first public key in the first digital certificate to obtain the second decryption result; and compare the second decryption result with the random data, and judge whether the second decryption result is authenticated successfully. It should be noted that, for the process of authenticating of the second authentication module 13, reference may be made to the foregoing description of the specific implementation of the second authentication module 13, and repeated description is not to be provided.

The key device 200 is further configured to encrypt the random data with the first private key generated in advance to obtain the second encrypted data. It should be noted that here, for the interaction between the second authentication module 13 and the key device 200, reference may be made to the detailed description for FIG. 4, and repeated description is not to be provided.

In some implementations, the first digital certificate includes the identity information of the protected object; the third authentication module 14 is specifically configured to, in response to that the key device 200 is authenticated successfully, parse the identity information of the protected object in the first digital certificate, and acquire the identity information of the protected object stored in advance; and compare the identity information obtained by parsing with the identity information stored in advance, to judge whether the identity information of the protected object is authenticated successfully.

It should be noted that, for the process of authenticating of the third authentication module 14, reference may be made to the foregoing description of the specific implementation of the third authentication module 14, and repeated description is not to be provided.

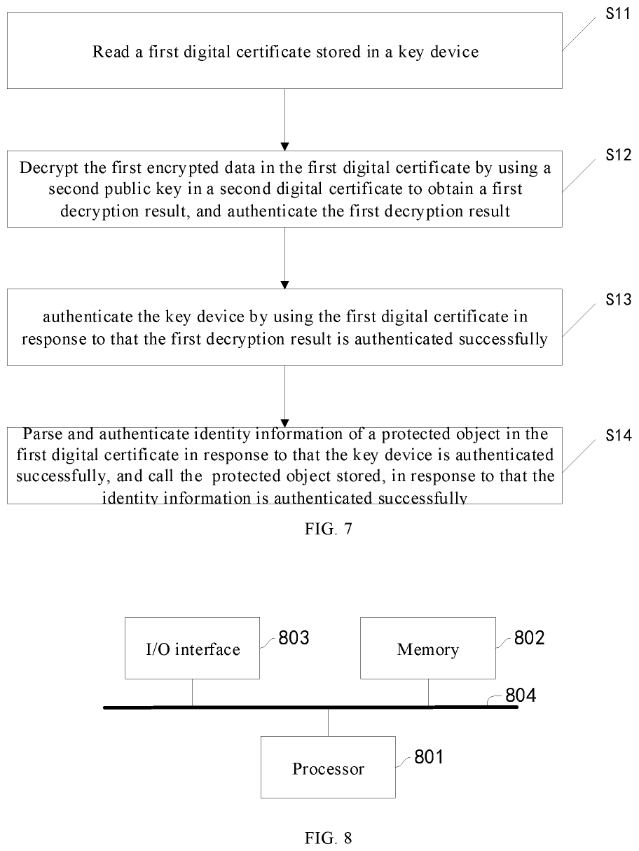

An embodiment of the present disclosure further provides an information authentication method. FIG. 7 is a schematic flowchart of an information authentication method according to an embodiment of the present disclosure. A main body for implementing the information authentication method is the processor 100 mentioned above, and as shown in FIG. 7, the method includes following steps S11 to S14.

S11, reading a first digital certificate stored in a key device; first encrypted data in the first digital certificate is encrypted by using a second private key. It should be noted that, for a specific implementation process of step S11, reference may be made to the specific description of the device driving module 11, and repeated description is not to be provided.

S12, decrypting the first encrypted data in the first digital certificate by using a second public key in a second digital certificate to obtain a first decryption result, and authenticating the first decryption result. The second public key in the second digital certificate is paired with the second private key. It should be noted that, for a specific implementation process of step S12, reference may be made to the specific description of the process of authenticating of the first authentication module 12, and repeated description is not to be provided.

S13, authenticating the key device by using the first digital certificate in response to that the first decryption result is authenticated successfully. It should be noted that, for a specific implementation process of step S13, reference may be made to the specific description of the process of authenticating of the second authentication module 13, and repeated description is not to be provided.

S14, parsing and authenticating identity information of a protected object in the first digital certificate in response to that the key device is authenticated successfully, and calling the stored protected object in response to that the identity information is authenticated successfully. It should be noted that, for a specific implementation process of step S14, reference may be made to the specific description of the process of authenticating of the third authentication module 14, and repeated description is not to be provided.

In the embodiment of the present disclosure, the first digital certificate stored in the key device 200 is read. It should be noted that the first encrypted data in the first digital certificate is encrypted by using the second private key; the second private key is paired with the second public key; the second public key is stored in the second digital certificate; the second digital certificate is pre-stored within the processor 100. The second public key preset in the second digital certificate is utilized to decrypt the first encrypted data in the first digital certificate, and the first decryption result is authenticated, so that the secure transmission of the first encrypted data is realized. Further, in response to that the first decryption result is authenticated successfully, the key device 200 is authenticated by using the first digital certificate. It should be noted that although the first digital certificate sent by the key device 200 is authenticated successfully, it does not represent that the key device 200 itself is legal, and the key device 200 may steal the first digital certificate authenticated successfully. Therefore, the first digital certificate which is authenticated successfully is used for further authenticating the key device 200 reversely, so that the identity authentication of the operating user of the processor 100 is realized. That is, the key device 200 currently mounted can be ensured to be legal in response to that the key device 200 is authenticated successfully. The identity information of the protected object in the first digital certificate is parsed and authenticated in response to that the key device 200 is authenticated successfully. It should be noted that, although the key device 200 is authenticated successfully, the identity information of the protected object in the first digital certificate may not be consistent with the identity information of the protected object currently stored in the processor 100, and therefore, after the identity information of the protected object in the first identity certificate is parsed, the identity information is further authenticated; and in response to that the identity information is authenticated successfully, it can represent that the object (i.e., the protected object in the first digital certificate) that the user instructs to be manipulate is the protected object stored in the processor 100, and thus the protected object is authorized to be available, and the secure call of the protected object is realized.

In some implementations, the first digital certificate includes the first encrypted data, a hash algorithm, and the first public key; the first encrypted data is obtained by encrypting the first hash value based on the second private key, the first hash value is obtained by processing the first public key generated by the key device 200 by using the hash algorithm; the first public key and the first private key are paired with each other.

The second digital certificate includes the second public key corresponding to the second private key. For step S12, the first encrypted data is decrypted by using the second public key, so as to obtain the first decryption result; the first public key is processed by using the hash algorithm in the first digital certificate to obtain a second hash value; and the second hash value is compared with the first decryption result to judge whether the first decryption result is authenticated successfully.

In some implementations, the first digital certificate includes the first encrypted data and the first public key; the first encrypted data is obtained by encrypting the first public key, generated by the key device 200, based on the second private key.

The second digital certificate includes the second public key corresponding to the second private key; for step S12, specifically, the first encrypted data is decrypted by using the second public key, so as to obtain the first decryption result; and the first public key in the first digital certificate is compared with the first decryption result to judge whether the first decryption result is authenticated successfully.

In some implementations, for step S13, specifically, in response to that the first decryption result is authenticated successfully, random data is generated and sent to the key device 200; the second encrypted data in the key device 200 is read, and the second encrypted data is decrypted by using the first public key in the first digital certificate to obtain the second decryption result; the second decryption result is compared with the random data, to judge whether the second decryption result is authentically successfully; the second encrypted data is obtained by encrypting the random data by the key device 200 by using the first private key generated in advance.

In some implementations, the first digital certificate further includes the identity information of the protected object; for step S14, specifically, in response to that the key device 200 is authenticated successfully, the identity information of the protected object in the first digital certificate is parsed, and the identity information of the protected object stored in advance is acquired; and the identity information obtained by parsing is compared with the identity information stored in advance, to judge whether the identity information of the protected object is authenticated successfully.

FIG. 8 is a schematic diagram of a structure of a computer device according to an embodiment of the present disclosure. As shown in FIG. 8, an embodiment of the present disclosure provides a computer device including: at least one processor 801, a memory 802, at least one I/O interface 803. The memory 802 stores at least one program that is to be executed by the at least processor to cause the at least one processor to implement the information authentication method as described above; the at least one I/O interface 803 is connected between the at least one processor 801 and the memory 802 and is configured to enable information interaction between the at least one processor 801 and the memory 802.

Each processor 801 is a device having a data processing capability, and includes, but is not limited to, a central processing unit (CPU) or the like; the memory 802 is a device having a data storage capability, and includes, but is not limited to, a random access memory (RAM, such as SDRAM, DDR, etc.), a read-only memory (ROM), an electrically erasable programmable read-only memory (EPROM), and FLASH; the at least one I/O interface (read/write interface) 803 is connected between the at least one processor 801 and the memory 802 and is capable to enable the information interaction between the at least one processor 801 and the memory 802, and includes, but is not limited to, a data bus or the like.

In some implementations, the processor 801, the memory 802, and the I/O interface 803 are interconnected by a bus 804, and then is connected to other components of the computing device.

According to an embodiment of the present disclosure, there is also provided a non-transitory computer readable storage medium storing a computer program thereon, and the computer program is to be executed by a processor to cause the processor to implement the information authentication method as described above.

In particular, the processes described above with reference to the flowcharts may be implemented as computer software programs, according to the embodiments of the present disclosure. For example, an embodiment of the present disclosure includes a computer program product, including a computer program embodied on a machine-readable medium; the computer program includes program codes for performing the method illustrated in the flowchart. In such embodiment, the computer program may be downloaded and installed from a network via a communication component, and/or installed from a removable medium. The functions defined above in the system of the present disclosure are performed by executing the computer program through a central processing unit (CPU).

It should be noted that the non-transitory computer readable storage medium shown in the present disclosure may be a computer readable signal medium or a computer readable storage medium or any combination of such two. The computer readable storage medium may be, for example, but not limited to, an electronic, magnetic, optical, electromagnetic, infrared, or semiconductor system, apparatus, or device, or any combination thereof. More specific examples of the computer readable storage medium may include, but are not limited to, an electrical connection including one or more wires, a portable computer diskette, a hard disk, a random access memory (RAM), a read-only memory (ROM), an erasable programmable read-only memory (erasable EPROM or flash memory), an optical fiber, a portable compact disc read-only memory (CD-ROM), an optical storage device, a magnetic storage device, or any suitable combination thereof. In the present disclosure, the computer readable storage medium may be any tangible medium that contains or stores programs for use by or in connection with an instruction execution system, apparatus, or device. In the present disclosure, the computer readable signal medium may include a data signal, with computer readable program codes embodied therein, for example, propagated in baseband or as part of a carrier wave. Such data signal propagated may take any of a variety of forms, including, but not limited to, electromagnetic signals, optical signals, or any suitable combination thereof. The computer readable signal medium may be any non-transitory computer readable storage medium; the non-transitory computer readable storage medium may transmit, propagate, or transport programs for use by or in connection with an instruction execution system, apparatus, or device. The program codes embodied on the non-transitory computer readable storage medium may be transmitted through any suitable medium, including, but not limited to, wireless, wired, optical cable, RF (a radio frequency) or any suitable combination thereof.

The flowchart and block diagrams in the drawings illustrate architecture, functionality, and operation of possible implementations of a system, a method and a computer program product according to various embodiments of the present disclosure. In this regard, each block in the flowcharts or block diagrams may represent a module, program segment(s), or a portion of a code, which includes one or more executable instructions for implementing specified logical function(s). It should also be noted that, in some alternative implementations, functions noted in the blocks may occur out of the order noted in the drawings. For example, two blocks being successively connected may, in fact, be performed substantially concurrently, or sometimes may be performed in the reverse order, depending upon the functionality involved. It will also be noted that each block of the block diagrams and/or flowcharts, and combinations of blocks in the block diagrams and/or flowcharts, may be implemented by special purpose hardware-based systems that perform the specified functions or operations, or combinations of special purpose hardware and computer instructions.

It should be understood that the above embodiments are merely exemplary embodiments adopted to explain the principles of the present disclosure, and the present disclosure is not limited thereto. It will be apparent to one of ordinary skill in the art that various changes and modifications may be made without departing from the spirit and scope of the present disclosure, and such changes and modifications also fall within the scope of the present disclosure.

1. A processor, communicatively connected to a key device, comprising a device driving module, a first authentication module, a second authentication module and a third authentication module, wherein
the device driving module is configured to drive the key device and read a first digital certificate stored in the key device; first encrypted data in the first digital certificate is encrypted by using a second private key;
the first authentication module is configured to decrypt the first encrypted data in the first digital certificate by using a second public key preset in a second digital certificate to obtain a first decryption result, and authenticate the first decryption result; the second public key in the second digital certificate is paired with the second private key;
the second authentication module is configured to authenticate the key device by using the first digital certificate in response to that the first decryption result is authenticated successfully; and
the third authentication module is configured to parse and authenticate identity information of a protected object in the first digital certificate in response to that the key device is authenticated successfully, and call the protected object stored, in response to that the identity information is authenticated successfully.

2. The processor of claim 1, wherein the first digital certificate comprises the first encrypted data, a hash algorithm, and a first public key; the first encrypted data is obtained by encrypting a first hash value based on the second private key, and the first hash value is obtained by processing the first public key generated by the key device by using the hash algorithm; the first public key and the first private key are paired with each other; and
the second digital certificate comprises the second public key corresponding to the second private key; the first authentication module is configured to decrypt the first encrypted data by using the second public key to obtain the first decryption result; process the first public key by using the hash algorithm in the first digital certificate to obtain a second hash value; and compare the second hash value with the first decryption result to judge whether the first decryption result is authenticated successfully.

3. The processor of claim 1, wherein the first digital certificate comprises the first encrypted data and a first public key; the first encrypted data is obtained by encrypting the first public key generated by the key device based on the second private key; and
the second digital certificate comprises the second public key corresponding to the second private key; the first authentication module is configured to decrypt the first encrypted data by using the second public key to obtain the first decryption result; and compare the first public key in the first digital certificate with the first decryption result to judge whether the first decryption result is authenticated successfully.

4. The processor of claim 2, wherein the second authentication module is configured to generate random data and send the random data to the key device in response to that the first decryption result is authenticated successfully; read second encrypted data in the key device, and decrypt the second encrypted data by using the first public key in the first digital certificate to obtain a second decryption result; compare the second decryption result with the random data, to judge whether the second decryption result is authenticated successfully; the second encrypted data is obtained by encrypting the random data by the key device by using the first private key generated in advance.

5. The processor of claim 4, wherein the first digital certificate comprises the identity information of the protected object; and
the third authentication module is configured to parse the identity information of the protected object in the first digital certificate, and acquire the identity information of the protected object stored in advance in response to that the key device is authenticated successfully; and compare the identity information obtained by parsing with the identity information stored in advance, to judge whether the identity information of the protected object is authenticated successfully.

6. An information authentication system, comprising a key device and the processor of claim 1, wherein the key device is communicatively connected to the processor; the processor comprises a device driving module, a first authentication module, a second authentication module and a third authentication module;
the key device is configured to store a first digital certificate; first encrypted data in the first digital certificate is encrypted by using a second private key;
the device driving module is configured to drive the key device and read a first digital certificate stored in the key device:
the first authentication module is configured to decrypt the first encrypted data in the first digital certificate by using a second public key in a second digital certificate stored in advance to obtain a first decryption result, and authenticate the first decryption result; the second public key in the second digital certificate is paired with the second private key;
the second authentication module is configured to authenticate the key device by using the first digital certificate in response to that the first decryption result is authenticated successfully; and
the third authentication module is configured to parse and authenticate identity information of a protected object in the first digital certificate in response to that the key device is authenticated successfully, and call the protected object stored, in response to that the identity information is authenticated successfully.

7. The information authentication system of claim 6, wherein the second authentication module is configured to generate random data and send the random data to the key device in response to that the first decryption result is authenticated successfully; and read second encrypted data, and decrypt the second encrypted data by using the first public key in the first digital certificate to obtain a second decryption result; compare the second decryption result with the random data, to judge whether the second decryption result is authenticated successfully; and
the key device is further configured to encrypt the random data by using a first private key generated in advance to obtain the second encrypted data.

8. The information authentication system of claim 6, wherein the key device comprises a hardware security module (HSM).

9. An information authentication system, comprising a key device, an authentication device, and the processor of claim 1, wherein the key device, the processor and the authentication device are communicatively connected to each other; the processor comprises a device driving module, a first authentication module, a second authentication module and a third authentication module;
the key device is configured to store a first digital certificate; first encrypted data in the first digital certificate is encrypted by using a second private key;
the authentication device is configured to generate the first digital certificate and a second digital certificate; a second public key in the second digital certificate is paired with the second private key;
the device driving module is configured to drive the key device and read the first digital certificate stored in the key device;
the first authentication module is configured to decrypt the first encrypted data in the first digital certificate by using the second public key in the second digital certificate to obtain a first decryption result, and authenticate the first decryption result;
the second authentication module is configured to authenticate the key device by using the first digital certificate in response to that the first decryption result is authenticated successfully; and
the third authentication module is configured to parse and authenticate identity information of a protected object in the first digital certificate in response to that the key device is authenticated successfully, and call the protected object stored, in response to that the identity information is authenticated successfully.

10. The information authentication system of claim 9, wherein the authentication device comprises a generation module and an encryption module;
the key device is configured to generate a first private key and a first public key; and acquire and store the first digital certificate;
the generation module is configured to generate the second private key and the second digital certificate corresponding to the second private key; and
the encryption module is configured to read the first public key, generate the first digital certificate according to the second private key and the first public key, and write the first digital certificate into the key device.

11. The information authentication system of claim 10, wherein the encryption module is configured to process the first public key by using a hash algorithm to obtain a first hash value; encrypt the first hash value by using the second private key to obtain the first encrypted data; and
the first digital certificate comprises the first encrypted data, the hash algorithm, and the first public key; the second digital certificate comprises the second public key corresponding to the second private key; the first authentication module is configured to decrypt the first encrypted data by using the second public key to obtain the first decryption result; process the first public key by using the hash algorithm in the first digital certificate to obtain a second hash value; and compare the second hash value with the first decryption result to judge whether the first decryption result is authenticated successfully.

12. The information authentication system of claim 10, wherein the encryption module is configured to encrypt the first public key by using the second private key to obtain the first encrypted data; and
the first digital certificate comprises the first encrypted data and the first public key; the second digital certificate comprises the second public key corresponding to the second private key; the first authentication module is configured to decrypt the first encrypted data by using the second public key to obtain the first decryption result; and compare the first public key in the first digital certificate with the first decryption result to judge whether the first decryption result is authenticated successfully.

13. The information authentication system of claim 11, wherein the second authentication module is configured to generate random data and send the random data to the key device in response to that the first decryption result is authenticated successfully; and read second encrypted data, and decrypt the second encrypted data by using the first public key in the first digital certificate to obtain a second decryption result; compare the second decryption result with the random data, to judge whether the second decryption result is authenticated successfully; and
the key device is further configured to encrypt the random data by using a first private key generated in advance to obtain the second encrypted data.

14. The information authentication system of claim 13, wherein the first digital certificate comprises the identity information of the protected object;
the third authentication module is configured to parse the identity information of the protected object in the first digital certificate, and acquire the identity information of the protected object stored in advance in response to that the key device is authenticated successfully; and compare the identity information obtained by parsing with the identity information stored in advance, to judge whether the identity information of the protected object is authenticated successfully.

15. An information authentication method, comprising:
reading a first digital certificate stored in a key device, wherein first encrypted data in the first digital certificate is encrypted by a second private key;
decrypting the first encrypted data in the first digital certificate by using a second public key in a second digital certificate to obtain a first decryption result, and authenticating the first decryption result, wherein the second public key in the second digital certificate is paired with the second private key;
authenticating the key device by using the first digital certificate in response to that the first decryption result is authenticated successfully; and
parsing and authenticating identity information of a protected object in the first digital certificate in response to that the key device is authenticated successfully, and calling the protected object stored, in response to that the identity information is authenticated successfully.

16. A computer device, comprising: a processor, a memory and a bus, wherein the memory stores machine-readable instructions to be executed by the processor; the processor and the memory are communicated with each other over the bus during the computer device operating; the machine-readable instructions cause the processor to perform the information authentication method of claim 15.

17. A non-transitory computer readable storage medium storing thereon a computer program, the computer program is to be executed by a processor to cause the processor to perform the information authentication method of claim 15.

18. The processor of claim 3, wherein the second authentication module is configured to generate random data and send the random data to the key device in response to that the first decryption result is authenticated successfully; read second encrypted data in the key device, and decrypt the second encrypted data by using the first public key in the first digital certificate to obtain a second decryption result; compare the second decryption result with the random data, to judge whether the second decryption result is authenticated successfully; the second encrypted data is obtained by encrypting the random data by the key device by using a first private key generated in advance.

19. The processor of claim 18, wherein the first digital certificate comprises the identity information of the protected object; and
the third authentication module is configured to parse the identity information of the protected object in the first digital certificate, and acquire the identity information of the protected object stored in advance in response to that the key device is authenticated successfully; and compare the identity information obtained by parsing with the identity information stored in advance, to judge whether the identity information of the protected object is authenticated successfully.

20. The information authentication system of claim 12, wherein the second authentication module is configured to generate random data and send the random data to the key device in response to that the first decryption result is authenticated successfully; and read second encrypted data, and decrypt the second encrypted data by using the first public key in the first digital certificate to obtain a second decryption result; compare the second decryption result with the random data, to judge whether the second decryption result is authenticated successfully; and
the key device is further configured to encrypt the random data by using a first private key generated in advance to obtain the second encrypted data.
